(19) United States
(12) Patent Application Publication
(10) Pub. No.: US 2008/0275781 A1
(43) Pub. Date: Nov. 6, 2008

(54) INTERACTIVE ADVERTISING PLATFORM FOR AFTERMARKET AUTOMOTIVE INDUSTRY

(76) Inventors: Thomas J. Moore, Seal Beach, CA (US); William C. Kelley, Carson, CA (US); Andrew R. Wilson, (US)

Correspondence Address: KAUTH , POMEROY , PECK & BAILEY ,LLP, P.O. BOX 19152, IRVINE, CA, 92623, US

(21) Appl. No.: 12/111,151

(22) Filed: Apr. 28, 2008

Related U.S. Application Data
(60) Provisional application No. 60/914,641, filed on Apr. 27, 2007.
(60) Provisional application No. 60/914,639, filed on Apr. 27, 2007.

(51) Int. Cl. G06Q 30/00

(52) U.S. Cl. 705/14

(57) ABSTRACT

Systems and methods for associating aftermarket parts with information concerning a vehicle are described. One embodiment includes obtaining information concerning a vehicle year, make, and model, providing a directory of aftermarket parts compatible with the obtained vehicle year, make, and model, selecting at least one aftermarket part from the directory, storing a vehicle profile including the selected aftermarket part, associating an advertisement with the selected aftermarket part, receiving an instruction to display the stored profile, retrieving the stored profile and the associated advertisement, displaying the stored profile and the associated advertisement, and recording information concerning the display of the associated advertisement.

### PRIORITY CLAIM

The current invention claims priority to U.S. Provisional Application No. 60/914,641, filed Apr. 27, 2007, and U.S. Provisional Application No. 60/914,639 filed Apr. 27, 2007, the disclosure of which is incorporated herein by reference in its entirety.

### BACKGROUND

The present invention relates generally to advertising and more specifically to the provision of targeted advertising to users of websites containing information relating to the aftermarket modification of automobiles.

Modification of cars and other types of vehicle such as bicycles, boats, and recreational vehicles (RVs) to improve performance and/or aesthetics is a popular past time. Numerous websites have been developed to provide information concerning vehicles and modifications that can be performed to vehicles. A number of online communities also exist that enable users to create a profile for their vehicle and specify aftermarket modifications that have been performed to the vehicle.

### SUMMARY OF THE INVENTION

Systems and methods for associating aftermarket parts with information concerning a vehicle are described. One embodiment includes obtaining information concerning a vehicle year, make, and model, providing a directory of aftermarket parts compatible with the obtained vehicle year, make, and model, selecting at least one aftermarket part from the directory, storing a vehicle profile including the selected aftermarket part, associating an advertisement with the selected aftermarket part, receiving an instruction to display the stored profile, retrieving the stored profile and the associated advertisement, displaying the stored profile and the associated advertisement, and recording information concerning the display of the associated advertisement.

### BRIEF DESCRIPTION OF THE DRAWINGS

FIG. 1 is a schematic view of a system for providing context specific advertising relating to automotive aftermarket products.

FIG. 1A is a web page showing a vehicle profile and contextually relevant advertising in accordance with an embodiment of the invention.

FIG. 1B is a web page showing an online marketplace that can be displayed by a syndicated server using information provided by an advertising server in accordance with an embodiment of the invention.

FIG. 2 is a screen shot of a web page including a form for capturing information concerning a vehicle in accordance with an embodiment of the present invention.

FIG. 3 is a screen shot of a web page including options to enter information concerning categories of aftermarket products added to a vehicle and pictures in accordance with an embodiment of the invention.

FIG. 4 is a screen shot of a web page containing a form in which information relating to a vehicle can be entered in accordance with an embodiment of the invention.

FIG. 4A is a partial screen shot of a web page showing content in which vehicle specific products, product categories and product subcategories are highlighted with links to an online shopping search engine in accordance with an embodiment of the invention.

FIG. 5 is a design for a user interface enabling users to associate aftermarket products specified using standard terminology with an alias in accordance with an embodiment of the invention.

### DETAILED DESCRIPTION OF THE INVENTION

Turning now to the drawings, systems are described for providing aftermarket product information and/or advertising for display by automotive aftermarket websites that is appropriate to the context in which the advertising is displayed. The system uses a database containing information concerning vehicle aftermarket products to identify aftermarket products and/or advertising that is relevant to specific content. Advertisers can bid to place advertisements with respect to content relating to specific vehicles, identified by Year/Make/Model, vehicle uses, and/or specific aftermarket products. In a number of embodiments, a listing of aftermarket products relevant to a particular piece of content is combined with the content and each listed aftermarket product includes a link to advertisements from online retailers that supply the product. In many embodiments, advertisements from an advertiser are associated with content that references specific vehicle and/or aftermarket products. In several embodiments, references to vehicles and/or aftermarket products are identified using forms to capture information concerning the vehicle and/or the aftermarket products in a structured fashion. In several embodiments, the forms are generated using the database. In many embodiments, content includes freeform text and references to vehicles and/or aftermarket products are identified by performing text searches. In several embodiments, various terms that can be used to describe a vehicle or aftermarket product are accommodated using aliasing. In many embodiments, aliases are also useful in the entry of data to a database of aftermarket products and when performing user searches of the database.

Although the following refers to automobiles and the automotive aftermarket, embodiments of the invention can provide advertising relevant to other types of vehicles. In addition, the term “aftermarket products” is used throughout the application to refer to replacement parts, aftermarket parts and aftermarket accessories.

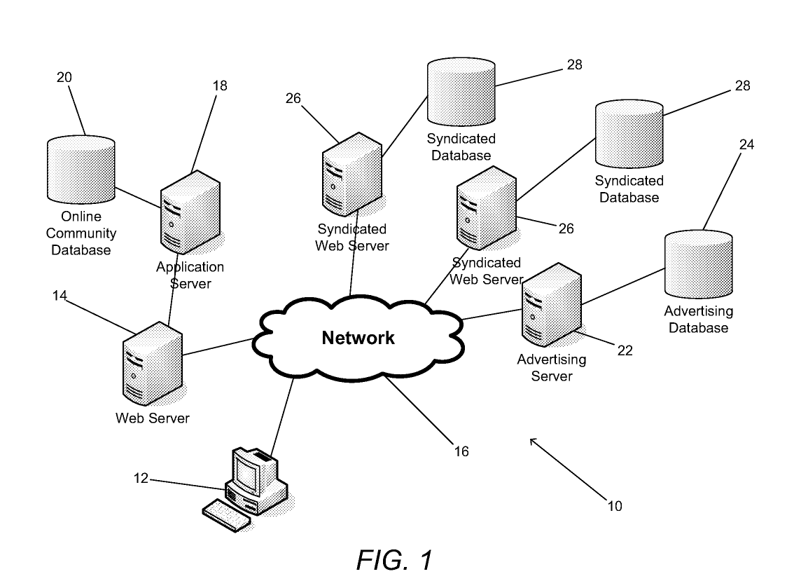

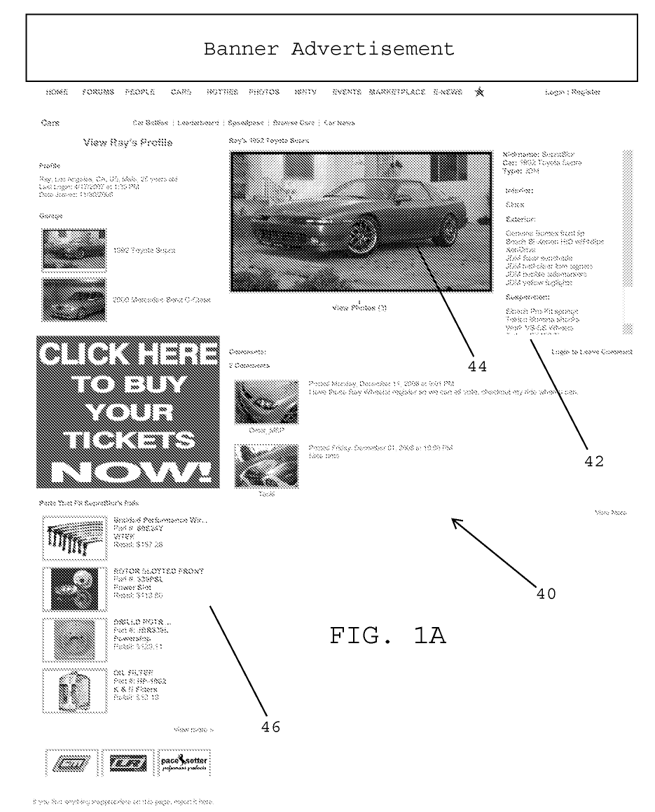

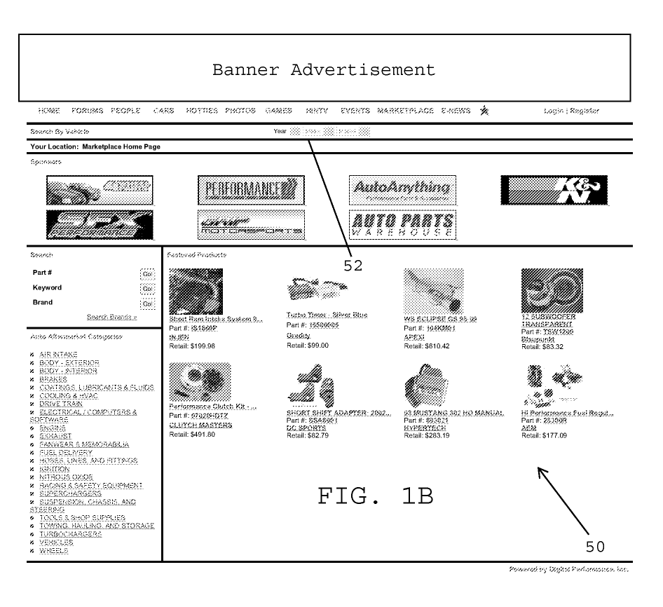

A system for displaying web pages combining content relevant to the automotive aftermarket with listings of aftermarket products and/or advertising relevant to the content in accordance with an embodiment of the invention is shown in FIG. 1. The system includes a user computing device 12 configured to communicate with a web server 14 via a network 16. The web server 14 is connected to an application server 18, which is connected to an online community database 20. The web server, application server and database are configured to support an online community including profiles of cars that describe aftermarket modifications performed on the cars. An advertising server 22 is also connected to the network 16. The advertising server includes an advertising database 24, which includes information concerning parts that can be used in the aftermarket modification of automobiles. The system also includes syndicated servers 26 that are connected to the network and syndicated databases 28. The syndicated servers utilize functionality of the web server 14, application server 18, and/or online community database 20 to provide access to an online community. In a number of embodiments, the online community accessed via a syndicated server can also be accessed via other sites. In many embodiments, an online community accessed via a syndicated server can only be accessed via the syndicated server. In several embodiments, a syndicated server utilizes the functionality of the advertising server 22 and/or the advertising database 24 to provide contextually relevant advertising, special offers and vertical shopping tools to visitors accessing sites hosted by the syndicated server. Vertical shopping tools can provide such information as customer reviews, similar product comparisons, availability information and price comparison information.

As discussed above, the web server 14, application server 18 and online community database 20 are configured to support an online community where users can post profiles of cars and describe aftermarket modifications that have been performed on the cars. The profiles can also include text and photos uploaded to the site by the user. Data concerning the profiles is typically stored on the online community database 20 and the application server coordinates user interactions with the profiles and the online community. The application server can provide messaging capabilities and the ability to associate comments and articles to a profile or an aspect of a profile such as a particular aftermarket modification. As will be discussed in further detail below, information entered by the user can be used by an advertising server in accordance with an embodiment of the invention to trigger the advertisements and other content that appear onscreen adjacent a car profile.

The advertising server 22 is connected to an advertising database 24 of automotive aftermarket products. In addition to information concerning products, the database also includes information concerning advertisers interested in providing advertisements in conjunction with content relating to specific vehicle types, specific vehicle uses and/or specific aftermarket products. The advertising server 22 is configured to identify references to automobiles, vehicle uses and aftermarket products within content. In a number of embodiments, these references are used to generate a list of aftermarket products. The advertising server 22 then provides the list of aftermarket products to the web server 14 or to a syndicated server 26. The web server 14 or syndicated server 26 can combine the advertisements with content to generate web pages viewable on a user's computer or other user device (e.g. mobile phone handset). When a user selects an aftermarket product from the list of aftermarket products, the advertising server provides the web server or syndicated server with advertisements from advertisers that have indicated interest in providing advertising in relation to the selected aftermarket product. In a number of embodiments, the advertising server 22 provides advertisements relevant to the content as a substitute or in addition to the list of aftermarket products.

In addition to identifying advertisers based upon vehicle type or aftermarket product type, advertisers can be identified using other categories such as the intended use of the vehicle (e.g. street racing, off road racing, etc.). In many embodiments, the advertising server responds to a reference to a particular vehicle, vehicle use, product category and/or aftermarket product in content by providing an advertisement from an advertiser that has paid the highest bid with respect to the advertising opportunity. In embodiments where the advertising server 22 provides a list of relevant aftermarket products, advertisers can bid to be the exclusive advertiser for a particular product and/or to be listed with greater prominence with respect to other advertisers. In other embodiments, advertisers do not bid to advertise. In several embodiments, advertisers pay a fixed price to secure advertising. In many embodiments, a wide variety of techniques can be used to enable advertisers to secure advertising and for collecting fees in return for displaying advertising to users.

In many embodiments, an advertiser sets up an account, specifies vehicles, product categories, products and/or intended vehicle uses of interest and the amount the advertiser is willing to pay for general context advertising and for context specific advertising. The payment can be higher, when a user clicks through the advertisement. In numerous embodiments, the advertising revenue is shared between the publisher of the content (e.g. a website of an online community) and the owner of the advertising server.

As discussed above advertising can be provided to syndicated servers to be combined with content provided by the syndicated servers. In addition, the syndicated servers can utilize the functionality of the web server, 14, application server 18 and/or the online community database 20 to provide an online community. A web page that could be provided by a syndicated server that provides access to an online community in accordance with an embodiment of the invention is shown in FIG. 1A. The web page 40 includes an area 42 in which information concerning a vehicle is provided, photographs of the vehicle 44 and contextually relevant advertising 46. In the illustrated embodiment, the profile on the web page 40 includes information concerning modifications to the interior and exterior of the vehicle and the advertising is relevant to the vehicle Year/Make/Model. In other embodiments, the contextually relevant advertising can be relevant to the specific modifications made to the interior and exterior of the vehicle.

In many embodiments, syndicated servers 26 include online marketplaces that communicate with the advertising server to enable users to search the advertising database 24 for aftermarket products. As the user searches the advertising database, the advertising server provides search results and contextually relevant advertising to the syndicated server being accessed by the user. A web page that could be provided by a syndicated server that enables searching of a database of aftermarket products in accordance with an embodiment of the invention is shown in FIG. 1B. The web site 50 includes fields 52 in which a user can enter information concerning the Year/Make/Model of a vehicle and a directory 50 that a user can use to select various categories of part without specifying a Year/Make/Model of vehicle. In several embodiments, the Make, Model and directory are populated by querying a database of aftermarket products, where each of the products includes vehicle fitment information and/or is categorized according to at least a vehicle product category and, in many instances, one or more vehicle product subcategories. In many embodiments, the web site provides Year/Make/Model, product category, product subcategory, and product selections to a server that uses the information to query a database of aftermarket products and provide, Make, Model, product category, product subcategory, and product information. In several embodiments, the exchange of information is conducted via a series of XML calls. A database of aftermarket products that can be queries in the manner outlined above is described in the U.S. Patent Application entitled “ONLINE SHOPPING SEARCH ENGINE FOR VEHICLE PARTS” filed Apr. 28, 2008, the disclosure of which is incorporated herein by reference in its entirety.

The selection of context relevant listings of aftermarket parts and/or advertising by the system in accordance with embodiments of the invention means that a user navigating between pages served by a web server or syndicated server experiences shifts in listings of aftermarket parts and/or advertising. The shifts in the listings of aftermarket products and/or advertising involve changes to reflect the content on each web page. In a number of embodiments, the advertisements can be banner advertisements that include links to an advertiser's web site or can be brief multimedia presentations.

In several embodiments, information concerning a user can also be considered in selecting advertising to display to the user. In a number of embodiments, a user with a profile in an online community can have advertising displayed based upon the content of the user's profile. In one example, a user accesses a website that is in the format of a magazine focused on RVs and motor homes. The user provides or has provided information previously that identifies the user as being the owner of a 2002 Ford 350 Diesel 4×4 that the user uses to tow a fifth-wheel camping trailer and for off roading. As the user moves through the website, the user is provided with a listing of aftermarket products, links to articles and advertisements relevant to the user's 2002 Ford 350. The list of aftermarket products could include, for example, products that enhance engine torque for 350 Ford Diesel engines to aid in towing, trailer stabilizing accessories and products that provide drivetrain and chassis protection for Ford 350s used for off roading. The advertisements and articles could similarly be directed to Ford 350s, towing and/or off roading.

In a number of embodiments, the manner in which a user enters information concerning a car profile when establishing a car profile within an online community facilitates the identification of vehicle type and any aftermarket modifications performed on the vehicle. In several embodiments, the user provides the application server with Year/Make/Model information for the vehicle and the purpose for which the vehicle is intended to be used. The application server can then provide the user with a series of questions or check boxes that constrain the user's answers to the questions. Information entered in a standardized fashion by the user can be used by an advertising server to identify a list of aftermarket products relevant to the profile. The list of aftermarket products can in turn be used to identify advertisers, as can the vehicle model and other information such as the intended use of the vehicle.

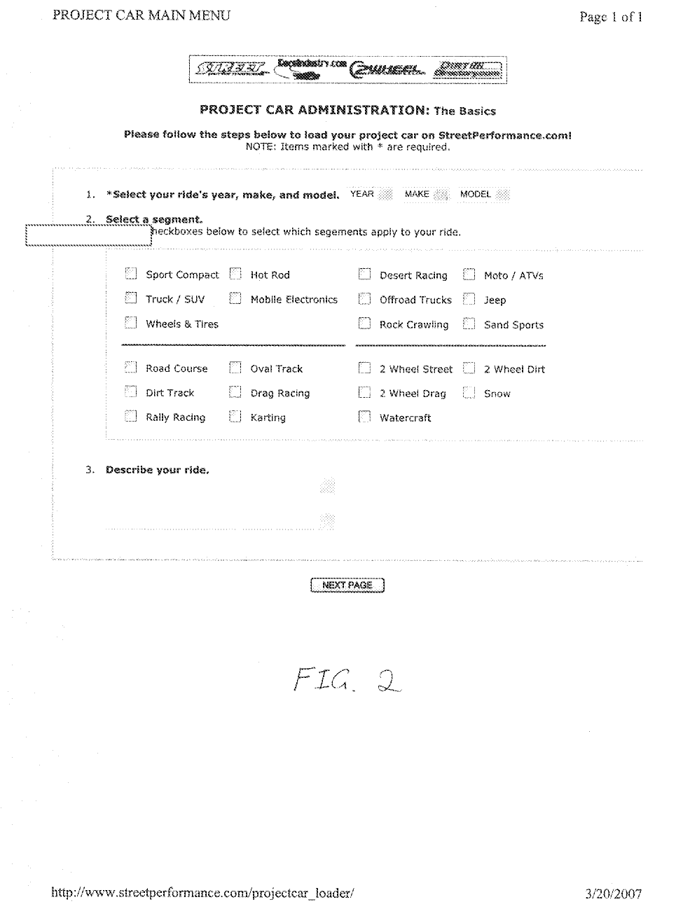

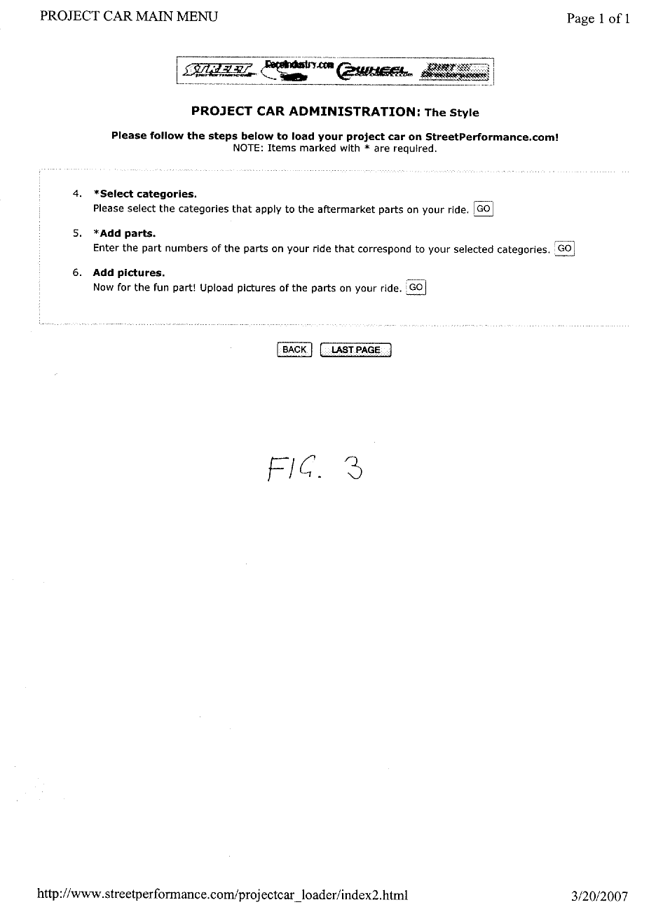

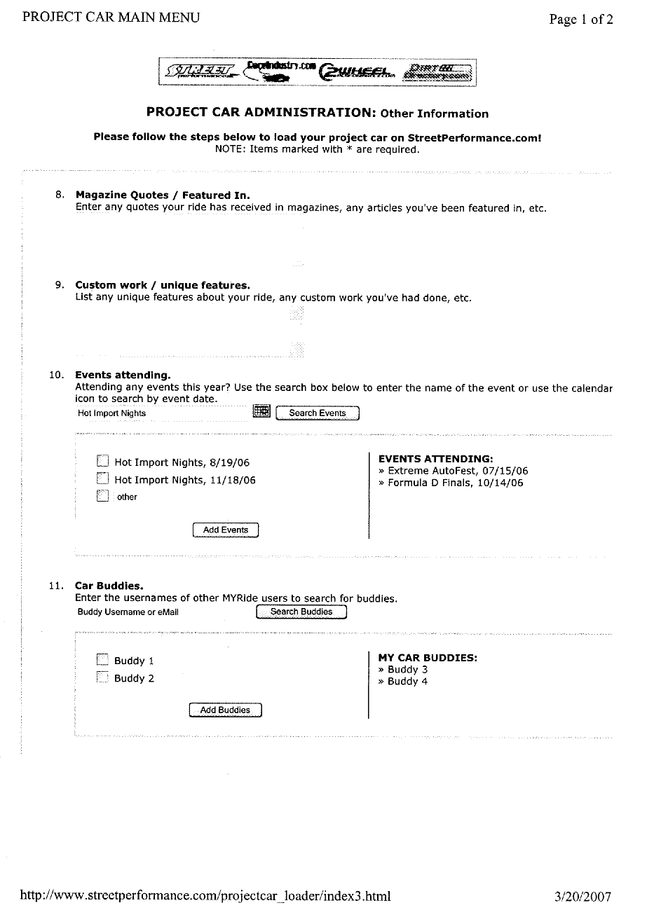

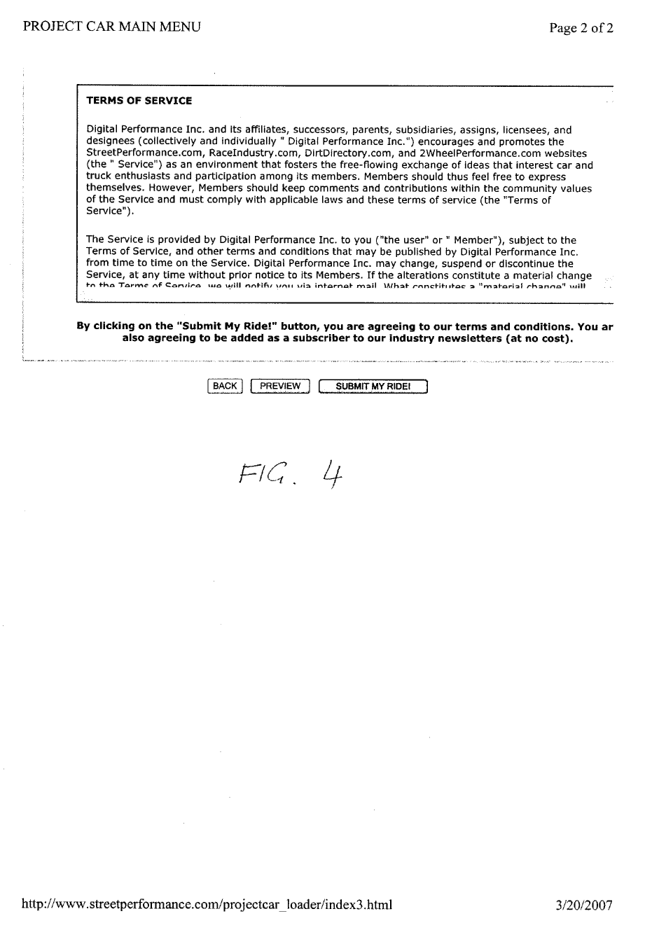

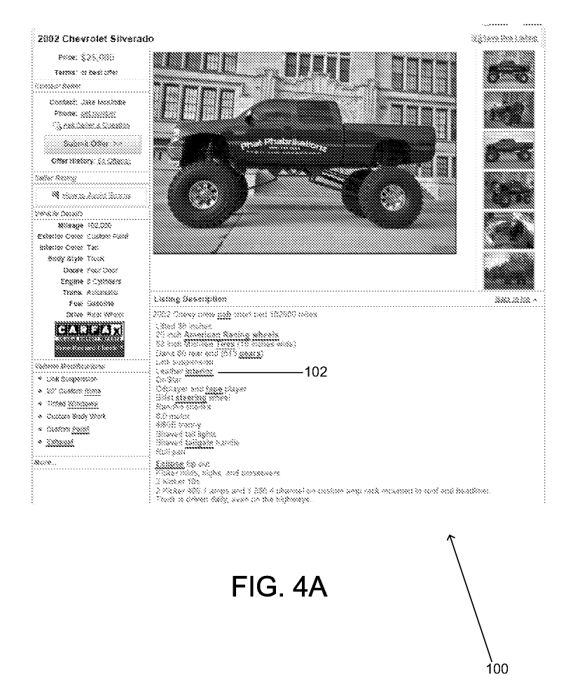

A web page that can be generated by a server and used to obtain information concerning a vehicle in accordance with an embodiment of the invention is shown in FIG. 2. A web page that can be generated by a server and used to obtain information concerning categories of parts, specific parts and pictures related to a vehicle in accordance with an invention is shown in FIG. 3. Once a vehicle Year/Make/Model is specified, the categories of parts and specific parts in those categories can be obtained from a database of aftermarket products such as the database 24 shown in FIG. 1. A web page that can be generated by a server and used to obtain additional information relevant to an online community is shown in FIG. 4. In addition to simply adding references to parts, users can also associate the logos of aftermarket product manufacturers with their profile. The logos can be contained within a database similar to the advertising database 24 shown in FIG. 1. The logos are typically configured to link to the manufacturer's website.

Providing pull down lists and check boxes in web pages for a user to enter information concerning a vehicle and/or aftermarket modifications performed to the vehicle in accordance with embodiments of the invention facilitates structured data capture. Structured data capture is a term that can be used to describe techniques that restrict the choices available to a user so that the data captured is less likely to include errors arising from variations in the input of data. In several embodiments, techniques can be used to accommodate variation in the entry of data by users. In a number of embodiments, the forms that are used to perform structured data capture are syndicated (i.e. provided) to a syndicated server. By providing the forms, the syndicated server can capture data that enables the data to be used by an advertising server to provide advertising relevant to information captured using the forms. In other embodiments, aliasing can be used to map freeform text to structured data. In this way, a user can enter information in a freeform text box and the captured structured data used to provide contextually relevant advertising. In several embodiments, aliasing is used to identify vehicle specific products within text and to create links between the identified vehicle specific products and information of interest. In a number of embodiments, the links are to an online shopping search engine similar to the online shopping search engines described in the U.S. Patent Application entitled “ONLINE SHOPPING SEARCH ENGINE FOR VEHICLE PARTS”, filed Apr. 28, 2008, the disclosure of which is incorporated by reference herein in its entirety. A partial screen shot of a website 100 in which vehicle specific products, product categories and product subcategories are identified within the text of the content by links 102 to an online shopping search engine in accordance with an embodiment of the invention is shown in FIG. 4A. In the illustrated embodiment, the links direct the user to a user interface provided by an online shopping search engine using at least the structured data captured from the website 100. For example, a vehicle specific product identified on the website is a link to a page concerning the vehicle specific product within the online shopping search engine. Similar links can be established for vehicle/engine configurations, product categories and product subcategories. Where the web page relates to a specific vehicle/engine configuration, then the products, categories and subcategories displayed by the online shopping search engine can be limited based upon the identified vehicle/engine configuration. In other embodiments, any of a variety of techniques can be used to link users to additional information based upon matching of website content against structured data.

A technique that can be used to facilitate consistency between content and a database of aftermarket products such as the database 24 shown in FIG. 1 in accordance with an embodiment of the invention is aliasing. Aliasing is a technique involving mapping variations to a single standard term. In many embodiments, a standard set of terminology such as that specified by the Automotive Aftermarket Industry Association (AAIA) is used to define a standard set of terminology to which variations will be mapped. Once a standard set is defined, records can be maintained of alternative terminology or aliases that are also used to reference the product identified by a standard term. In a number of embodiments, three different types of aliases are supported: platform/chassis alias, engine alias, and vehicle alias.

When content is reviewed by an advertising server in accordance with an embodiment of the invention and the content includes freeform text. The advertising server can review the text not just for references to standard terms, but to aliases that are then mapped to the standard terms. The ability to analyze freeform content can be useful in providing contextually relevant advertising for online magazines and other web pages that include unconstrained text.

Association of aliases with a standard term can be performed at a variety of stages. In a number of embodiments, aliases are used when adding information to a database of aftermarket products. Aliases used by aftermarket product manufacturers can be identified and mapped to standard terms to facilitate automatic addition of data to the database. The aliases identified during data addition can then be used when users conduct searches of the database or when reviewing content to identify advertising relevant to the content.

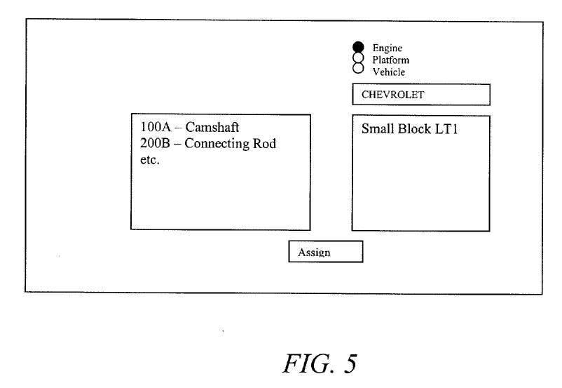

As an example, the alias “Small Block Chevrolet LT1” can be applied to about 100 AAIA records. In many embodiments, a user interface is provided to a manufacturer that enables the manufacturer to associate an alias with multiple parts in a standardized database. A design for a user interface that enables a user to associate aliases with parts in accordance with an embodiment of the invention is shown in FIG. 5.

While the above description contains many specific embodiments of the invention, these should not be construed as limitations on the scope of the invention, but rather as an example of one embodiment thereof. For example, systems in accordance with embodiments of the invention can be implemented on a single server or across multiple servers. In addition, the functions performed by the advertising server can be distributed across multiple servers including a web server and/or an application server. Moreover, advertising can be provided for combination with web pages forming part of a web based magazine and/or web pages forming part of an online community. Accordingly, the scope of the invention should be determined not by the embodiments illustrated, but by the appended claims and their equivalents.

what is claimed is:

1. A method of displaying information concerning a vehicle and contextually relevant advertising, comprising:
obtaining information concerning a vehicle year, make, and model;
providing a directory of aftermarket parts compatible with the obtained vehicle year, make, and model;
selecting at least one aftermarket part from the directory;
storing a vehicle profile including the selected aftermarket part;
associating at least one advertisement with the selected aftermarket part;
receiving an instruction to display the stored profile;
retrieving the stored profile and selecting at least one associated advertisement;
displaying the stored profile and the at least one selected advertisement; and
recording information concerning the display of the selected advertisement.
